(19) United States
(12) Patent Application Publication
(10) Pub. No.: US 2024/0057141 A1
(43) Pub. Date: Feb. 15, 2024

(54) NETWORK-COORDINATED MODE 2 SIDELINK IN UNLICENSED SPECTRUM

(71) Applicant: QUALCOMM Incorporated, San Diego, CA (US)

(72) Inventors: Jae Ho RYU, San Diego, CA (US); Chih-Hao LIU, San Diego, CA (US); Hari SANKAR, San Diego, CA (US)

(21) Appl. No.: 17/819,164

(22) Filed: Aug. 11, 2022

(51) Int. Cl. H04W 72/12; H04W 74/08; H04W 16/14

(52) U.S. Cl. CPC H04W 72/1252; H04W 74/0808; H04W 16/14

(57) ABSTRACT

Various aspects of the present disclosure generally relate to wireless communication. In some aspects, a user equipment (UE) may transmit, to a network node and via a buffer status report (BSR) or scheduling request (SR), a request indicating one or more parameters associated with sidelink communications in an unlicensed spectrum. The UE may receive, from the network node, a sidelink resource allocation indicating one or more resource block (RB) sets associated with the unlicensed spectrum. The UE may transmit, to a sidelink UE and based at least in part on the sidelink resource allocation and on a result of performing listen-before-talk (LBT), a sidelink communication. Numerous other aspects are described.

### FIELD OF THE DISCLOSURE

Aspects of the present disclosure generally relate to wireless communication and to techniques and apparatuses for network-coordinated Mode 2 sidelink in unlicensed spectrum.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

When communicating via sidelink, a transmitter user equipment (Tx UE) may perform its own resource selection and scheduling (e.g., as in Mode 2 operation) in an unlicensed spectrum, but doing so without coordination from a network node may lead to listen-before-talk (LBT) failures, collisions, and/or interference with other communications in the unlicensed spectrum. For example, especially when traffic loading in the unlicensed spectrum is high and/or the Tx UE is unaware of the status and/or resource usage of other nearby UEs, the Tx UE may experience LBT failures, collisions, and/or interference. While a network node may assist with resource selection and scheduling (e.g., as in Mode 1 operation) in the unlicensed spectrum, doing so may be difficult because the network node generally does not perform LBT procedures and may not have a sense of the unlicensed spectrum traffic in the geographic area of the Tx UE. For example, a network node may allocate resources for the Tx UE to use in the unlicensed spectrum, but if the Tx UE performs LBT prior to using the resources, and LBT fails, the Tx UE may not transmit using the allocated resources. In situations where the network node might allocate resource block (RB) sets to the Tx UE, an LBT failure on any one RB of the allocated RB sets may cause the Tx UE to avoid using some or all of the allocated RBs. This may lead to multiple inefficiencies when using unlicensed spectrum for sidelink communications. For example, when LBT fails, the network node (e.g., in Mode 1) and/or the Tx UE (e.g., in Mode 2) may need to schedule one or more RBs again, which consumes both processing and network resources for the network node and/or the Tx UE. In addition, dropped communications and rescheduling may cause delays in transmission, increasing latency for sidelink communications, among other issues.

Some techniques and apparatuses described herein enable network-coordinated Mode 2 sidelink in an unlicensed spectrum. For example, a UE may transmit, to a network node, a request indicating one or more parameters associated with sidelink communications in an unlicensed spectrum. The network node may determine, based on the request, a sidelink resource allocation that includes one or more RB sets. The sidelink resource allocation may be based at least in part on information associated with the unlicensed spectrum, provided by the UE (e.g., the one or more parameters) and/or other Ues. The network node may then transmit the sidelink resource allocation, which is based on information associated with the unlicensed spectrum, to the UE, and the UE may use the sidelink resource allocation and LBT for sidelink communications in the unlicensed spectrum. As a result, the network node is able to provide the UE with a sidelink resource allocation that is based on information about the unlicensed spectrum. The information provided to the network node may enable the network node to allocate resources (e.g., RB sets) to different Ues that are using the unlicensed spectrum, in a way that facilitates prevention of LBT failures, collisions, and interference. In this way, the network node may perform load balancing in the unlicensed spectrum for sidelink communications, where the resources for the sidelink communications are allocated by the network node (e.g., as in Mode 1) but scheduled by the UE (e.g., as in Mode 2). This may result in fewer dropped communications and/or LBT failures in the unlicensed spectrum, which may lead to less processing and network resources being consumed to schedule and reschedule communications, and may also lead to improved latency for sidelink communications by allocating resources that are more likely to pass an LBT procedure.

Some aspects described herein relate to a method of wireless communication performed by a UE. The method may include transmitting, to a network node and via a buffer status report (BSR) or scheduling request (SR), a request indicating one or more parameters associated with sidelink communications in an unlicensed spectrum. The method may include receiving, from the network node, a sidelink resource allocation indicating one or more RB sets associated with the unlicensed spectrum. The method may include transmitting, to a sidelink UE and based at least in part on the sidelink resource allocation and on a result of performing LBT, a sidelink communication.

Some aspects described herein relate to a method of wireless communication performed by a network node. The method may include receiving, from a UE and via a BSR or SR, a request indicating one or more parameters associated with sidelink communications in an unlicensed spectrum. The method may include transmitting, to the UE, a sidelink resource allocation indicating one or more RB sets associated with the unlicensed spectrum.

Some aspects described herein relate to a UE for wireless communication. The UE may include a memory and one or more processors coupled to the memory. The one or more processors may be configured to transmit, to a network node and via a BSR or SR, a request indicating one or more parameters associated with sidelink communications in an unlicensed spectrum. The one or more processors may be configured to receive, from the network node, a sidelink resource allocation indicating one or more RB sets associated with the unlicensed spectrum. The one or more processors may be configured to transmit, to a sidelink UE and based at least in part on the sidelink resource allocation and on a result of performing LBT, a sidelink communication.

Some aspects described herein relate to a network node for wireless communication. The network node may include a memory and one or more processors coupled to the memory. The one or more processors may be configured to receive, from a UE and via a BSR or SR, a request indicating one or more parameters associated with sidelink communications in an unlicensed spectrum. The one or more processors may be configured to transmit, to the UE, a sidelink resource allocation indicating one or more RB sets associated with the unlicensed spectrum.

Some aspects described herein relate to a non-transitory computer-readable medium that stores a set of instructions for wireless communication by a UE. The set of instructions, when executed by one or more processors of the UE, may cause the UE to transmit, to a network node and via a BSR or SR, a request indicating one or more parameters associated with sidelink communications in an unlicensed spectrum. The set of instructions, when executed by one or more processors of the UE, may cause the UE to receive, from the network node, a sidelink resource allocation indicating one or more RB sets associated with the unlicensed spectrum. The set of instructions, when executed by one or more processors of the UE, may cause the UE to transmit, to a sidelink UE and based at least in part on the sidelink resource allocation and on a result of performing LBT, a sidelink communication.

Some aspects described herein relate to a non-transitory computer-readable medium that stores a set of instructions for wireless communication by a network node. The set of instructions, when executed by one or more processors of the network node, may cause the network node to receive, from a UE and via a BSR or SR, a request indicating one or more parameters associated with sidelink communications in an unlicensed spectrum. The set of instructions, when executed by one or more processors of the network node, may cause the network node to transmit, to the UE, a sidelink resource allocation indicating one or more RB sets associated with the unlicensed spectrum.

Some aspects described herein relate to an apparatus for wireless communication. The apparatus may include means for transmitting, to a network node and via a BSR or SR, a request indicating one or more parameters associated with sidelink communications in an unlicensed spectrum. The apparatus may include means for receiving, from the network node, a sidelink resource allocation indicating one or more RB sets associated with the unlicensed spectrum. The apparatus may include means for transmitting, to a sidelink UE and based at least in part on the sidelink resource allocation and on a result of performing LBT, a sidelink communication.

Some aspects described herein relate to an apparatus for wireless communication. The apparatus may include means for receiving, from a UE and via a BSR or SR, a request indicating one or more parameters associated with sidelink communications in an unlicensed spectrum. The apparatus may include means for transmitting, to the UE, a sidelink resource allocation indicating one or more RB sets associated with the unlicensed spectrum.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of a slot format, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example associated with network-coordinated Mode 2 sidelink in an unlicensed spectrum, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

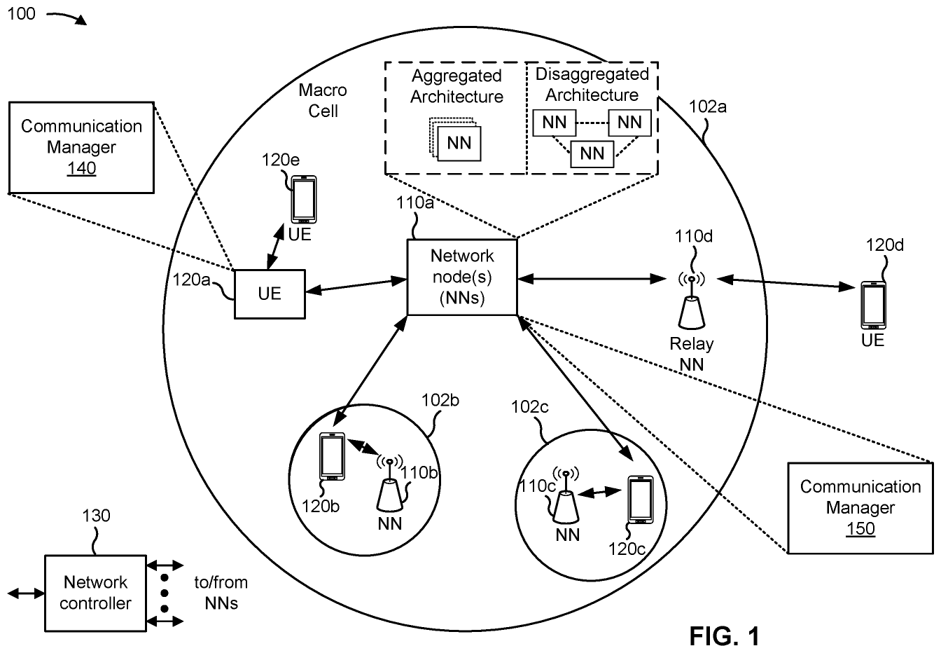

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple Ues 120 (shown as a UE 120a, a UE 120b, a UE 120c, a UE 120d, and a UE 120e), and/or other entities. A network node 110 is a network node that communicates with Ues 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (Cus), one or more distributed units (Dus), or one or more radio units (Rus)).

In some examples, a network node 110 is or includes a network node that communicates with Ues 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more Rus, one or more Cus, and/or one or more Dus. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by Ues 120 with service subscriptions. A pico cell may cover a relatively small geographic area and may allow unrestricted access by Ues 120 with service subscriptions. A femto cell may cover a relatively small geographic area (e.g., a home) and may allow restricted access by Ues 120 having association with the femto cell (e.g., Ues 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other Ues 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The Ues 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some Ues 120 may be considered machine-type communication (MTC) or evolved or enhanced machine-type communication (eMTC) Ues. An MTC UE and/or an eMTC UE may include, for example, a robot, a drone, a remote device, a sensor, a meter, a monitor, and/or a location tag, that may communicate with a network node, another device (e.g., a remote device), or some other entity. Some Ues 120 may be considered Internet-of-Things (IoT) devices, and/or may be implemented as NB-IoT (narrowband IoT) devices. Some Ues 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more Ues 120 (e.g., shown as UE 120a and UE 120e) may communicate directly using one or more sidelink channels (e.g., without using a network node 110 as an intermediary to communicate with one another). For example, the Ues 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a network node and via a BSR or SR, a request indicating one or more parameters associated with sidelink communications in an unlicensed spectrum; receive, from the network node, a sidelink resource allocation indicating one or more RB sets associated with the unlicensed spectrum; and transmit, to a sidelink UE and based at least in part on the sidelink resource allocation and on a result of performing LBT, a sidelink communication. Additionally, or alternatively, the communication manager 140 may perform one or more other operations described herein.

In some aspects, the network node may include a communication manager 150. As described in more detail elsewhere herein, the communication manager 150 may receive, from a UE and via a BSR or SR, a request indicating one or more parameters associated with sidelink communications in an unlicensed spectrum; and transmit, to the UE, a sidelink resource allocation indicating one or more RB sets associated with the unlicensed spectrum. Additionally, or alternatively, the communication manager 150 may perform one or more other operations described herein.

As indicated above, FIG. 1 is provided as an example. Other examples may differ from what is described with regard to FIG. 1.

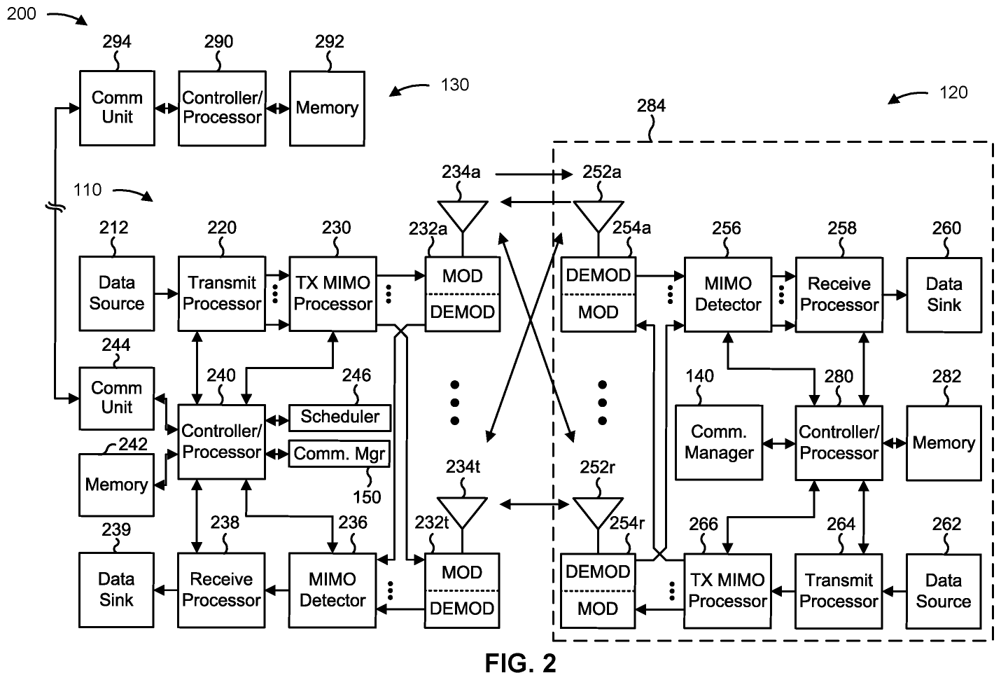

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more Cus, or one or more Dus.

At the network node 110, a transmit processor 220 may receive data, from a data source 212, intended for the UE 120 (or a set of Ues 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

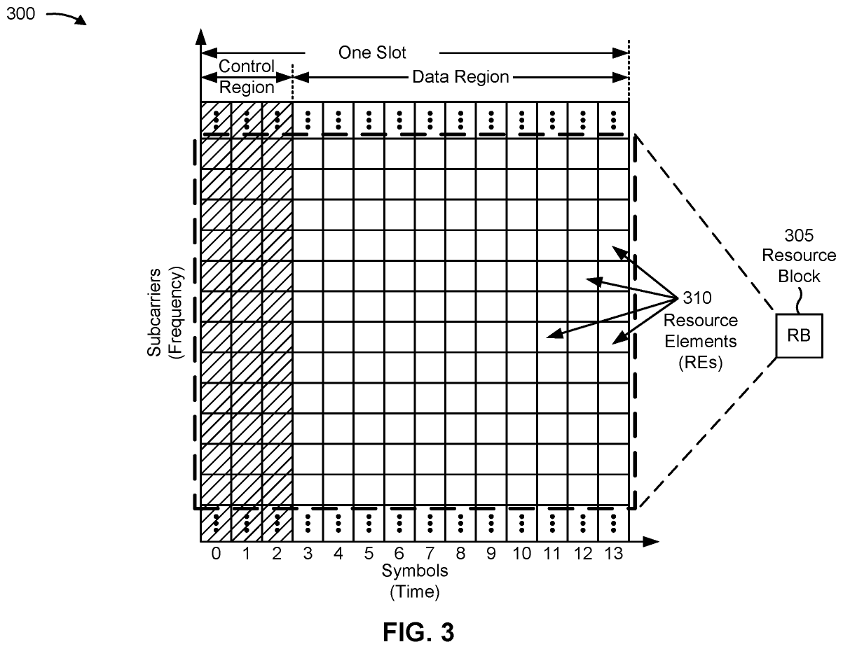

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-10).

At the network node 110, the uplink signals from UE 120 and/or other Ues may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more Ues 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-10).

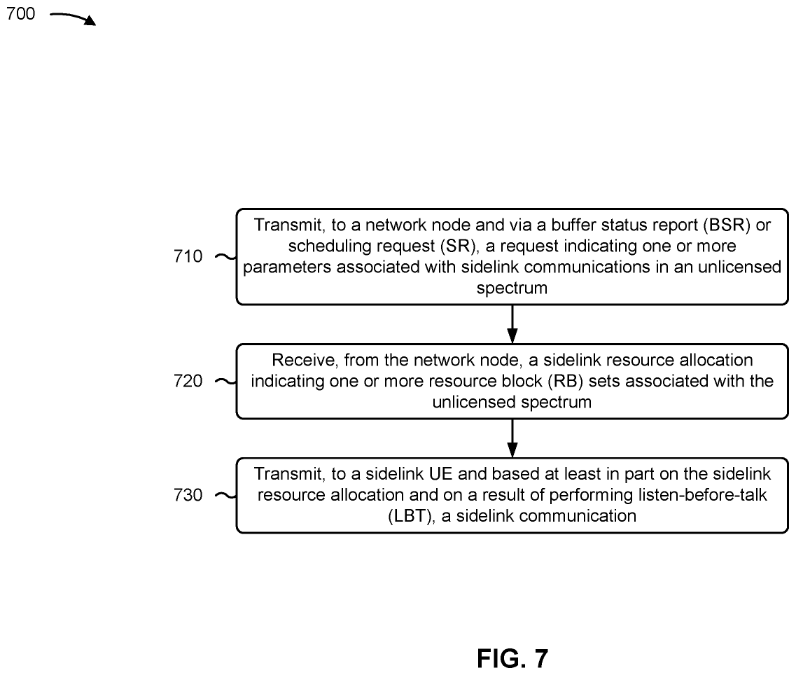

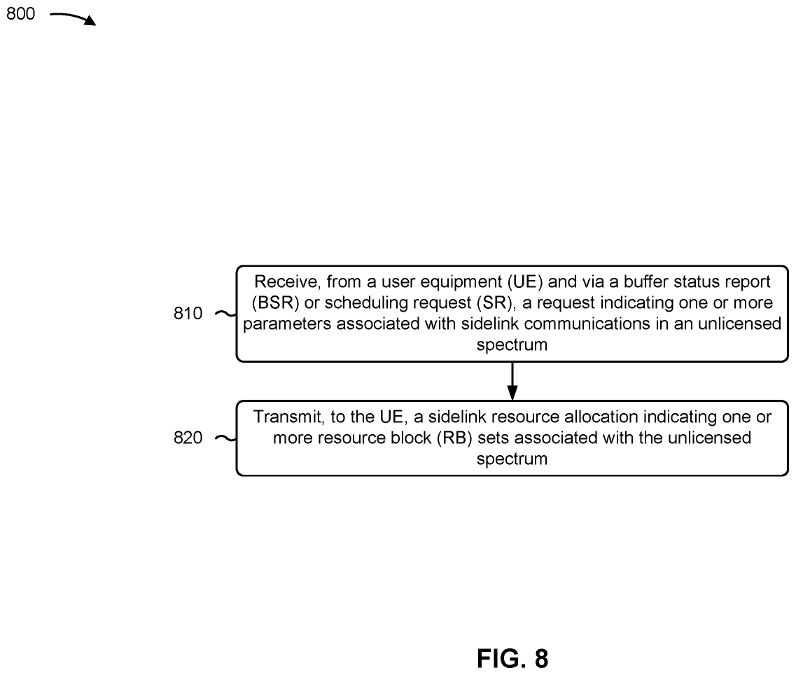

The controller/processor 240 of the network node 110, the controller/processor 280 of the UE 120, and/or any other component(s) of FIG. 2 may perform one or more techniques associated with network-coordinated Mode 2 sidelink in unlicensed spectrum, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for transmitting, to a network node and via a BSR or SR, a request indicating one or more parameters associated with sidelink communications in an unlicensed spectrum; means for receiving, from the network node, a sidelink resource allocation indicating one or more RB sets associated with the unlicensed spectrum; and/or means for transmitting, to a sidelink UE and based at least in part on the sidelink resource allocation and on a result of performing LBT, a sidelink communication. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving, from a UE and via a BSR or SR, a request indicating one or more parameters associated with sidelink communications in an unlicensed spectrum; and/or means for transmitting, to the UE, a sidelink resource allocation indicating one or more RB sets associated with the unlicensed spectrum. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example 300 of a slot format, in accordance with the present disclosure. As shown in FIG. 3, time-frequency resources in a radio access network may be partitioned into resource blocks, shown by a single resource block (RB) 305. An RB 305 is sometimes referred to as a physical resource block (PRB). An RB 305 includes a set of subcarriers (e.g., 12 subcarriers) and a set of symbols (e.g., 14 symbols) that are schedulable by a network node 110 as a unit. In some aspects, an RB 305 may include a set of subcarriers in a single slot. As shown, a single time-frequency resource included in an RB 305 may be referred to as a resource element (RE) 310. An RE 310 may include a single subcarrier (e.g., in frequency) and a single symbol (e.g., in time). A symbol may be referred to as an orthogonal frequency division multiplexing (OFDM) symbol. An RE 310 may be used to transmit one modulated symbol, which may be a real value or a complex value.

In some telecommunication systems (e.g., NR), RBs 305 may span 12 subcarriers with a subcarrier spacing of, for example, 15 kilohertz (kHz), 30 kHz, 60 kHz, or 120 kHz, among other examples, over a 0.1 millisecond (ms) duration. A radio frame may include 40 slots and may have a length of 10 ms. Consequently, each slot may have a length of 0.25 ms. However, a slot length may vary depending on a numerology used to communicate (e.g., a subcarrier spacing and/or a cyclic prefix format). A slot may be configured with a link direction (e.g., downlink or uplink) for transmission. In some aspects, the link direction for a slot may be dynamically configured.

As indicated above, FIG. 3 is provided as an example. Other examples may differ from what is described with respect to FIG. 3.

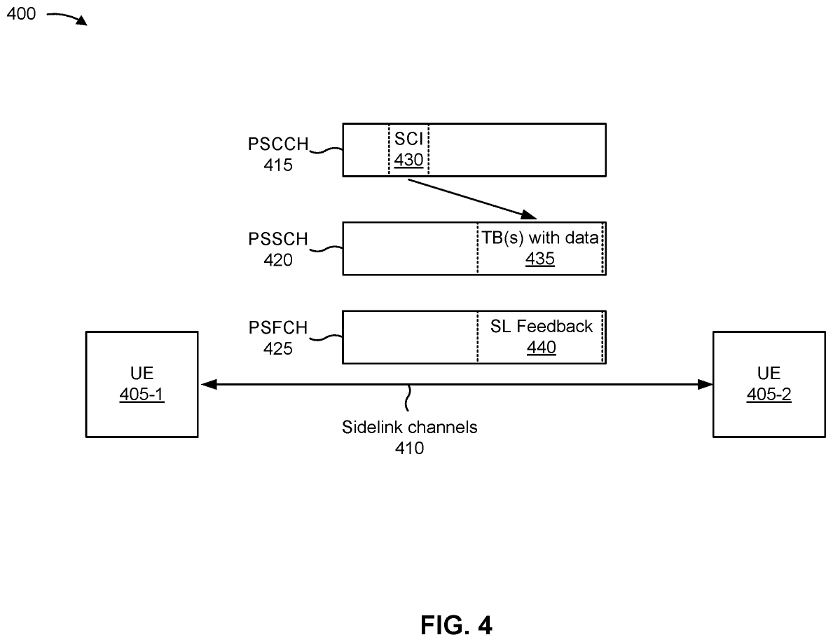

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

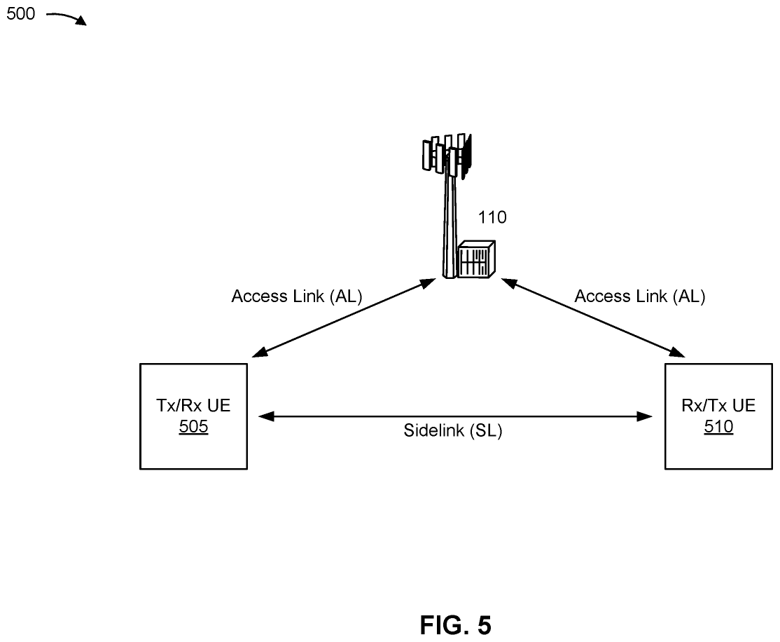

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 5 is provided as an example. Other examples may differ from what is described with respect to FIG. 5.

As described herein, sidelink channels may be scheduled by a Tx UE without network node involvement (e.g., according to Mode 2 PC5 as defined in 3GPP specifications and/or another standard). Accordingly, the Tx UE may transmit SCI to reserve one or more resources and/or schedule transmissions for the sidelink channel. The Tx UE may transmit to a single Rx UE (e.g., using a unicast link on the sidelink channel), to a plurality of Rx UEs (e.g., using a groupcast link, also referred to as a multicast link, on the sidelink channel), and/or to any Rx UEs within a geographic area (e.g., by broadcasting on the sidelink channel).

In both Mode 1 and Mode 2, a Tx UE may use an LBT procedure on at least one sidelink channel. For example, the Tx UE may wait for one or more symbols of a slot (e.g., a portion of a radio frame), and transmit (e.g., to an Rx UE) within that slot only when the Tx UE does not decode a transmission in those one or more symbols. The Tx UE may wait for a preconfigured amount of time or for a dynamic amount of time (e.g., determined based on a minimum amount of time, a maximum amount of time, an energy level associated with the transmission, a power class of the Tx UE, an antenna gain associated with the Rx UE, and/or another variable). Accordingly, the LBT procedure may include a carrier sensing multiple access (CSMA) procedure, a clear channel assessment (CCA) procedure, a carrier sensing adaptive transmission (CSAT) procedure, and/or another similar procedure. For example, the Tx UE may use an LBT procedure as set forth in the Institute of Electrical and Electronics Engineers (IEEE) LAN/MAN Standards Committee 802.11 standards, the IEEE Wireless Coexistence Technical Advisory Group (TAG) 802.19 standards, the European Telecommunications Standards Institute (ETSI) Harmonised European Standard (EN) 300 328, and/or another standard. The Tx UE may use the LBT procedure at least in part because the at least one sidelink channel is over an unlicensed band channel. For example, the at least one sidelink channel may use NR unlicensed (NR-U) spectrum.

While a Tx UE may perform its own resource selection and scheduling (e.g., as in Mode 2 operation) in an unlicensed spectrum, doing so without coordination from a network node may lead to LBT failures, collisions, and/or interference with other communications in the unlicensed spectrum. For example, especially when traffic loading in the unlicensed spectrum is high and/or the Tx UE is unaware of the status and/or resource usage of other nearby UEs, the Tx UE may experience LBT failures, collisions, and/or interference. While a network node may assist with resource selection and scheduling (e.g., as in Mode 1 operation) in the unlicensed spectrum, doing so may be difficult because the network node generally does not perform LBT procedures and may not have a sense of the unlicensed spectrum traffic in the geographic area of the Tx UE. For example, a network node may allocate resources for the Tx UE to use in the unlicensed spectrum, but if the Tx UE performs LBT prior to using the resources, and LBT fails, the Tx UE may not transmit using the allocated resources. In situations where the network node might allocate RB sets to the Tx UE, an LBT failure on any one RB of the allocated RB sets may cause the Tx UE to avoid using some or all of the allocated RBs. This may lead to multiple inefficiencies when using unlicensed spectrum for sidelink communications. For example, when LBT fails, the network node (e.g., in Mode 1) and/or the Tx UE (e.g., in Mode 2) may need to schedule one or more RBs again, which consumes both processing and network resources for the network node and/or the Tx UE. In addition, dropped communications and rescheduling may cause delays in transmission, increasing latency for sidelink communications, among other issues.

Some techniques and apparatuses described herein enable network-coordinated Mode 2 sidelink in an unlicensed spectrum. For example, a UE may transmit, to a network node, a request indicating one or more parameters associated with sidelink communications in an unlicensed spectrum. The network node may determine, based on the request, a sidelink resource allocation that includes one or more RB sets. The sidelink resource allocation may be based at least in part on information associated with the unlicensed spectrum, provided by the UE (e.g., the one or more parameters) and/or other UEs. The network node may then transmit the sidelink resource allocation, which is based on information associated with the unlicensed spectrum, to the UE, and the UE may use the sidelink resource allocation and LBT for sidelink communications in the unlicensed spectrum. As a result, the network node is able to provide the UE with a sidelink resource allocation that is based on information about the unlicensed spectrum. The information provided to the network node may enable the network node to allocate resources (e.g., RB sets) to different UEs that are using the unlicensed spectrum, in a way that facilitates prevention of LBT failures, collisions, and interference. In this way, the network node may perform load balancing in the unlicensed spectrum for sidelink communications, where the resources for the sidelink communications are allocated by the network node (e.g., as in Mode 1) but scheduled by the UE (e.g., as in Mode 2). This may result in fewer dropped communications and/or LBT failures in the unlicensed spectrum, which may lead to less processing and network resources being consumed to schedule and reschedule communications, and may also lead to improved latency for sidelink communications by allocating resources that are more likely to pass an LBT procedure.

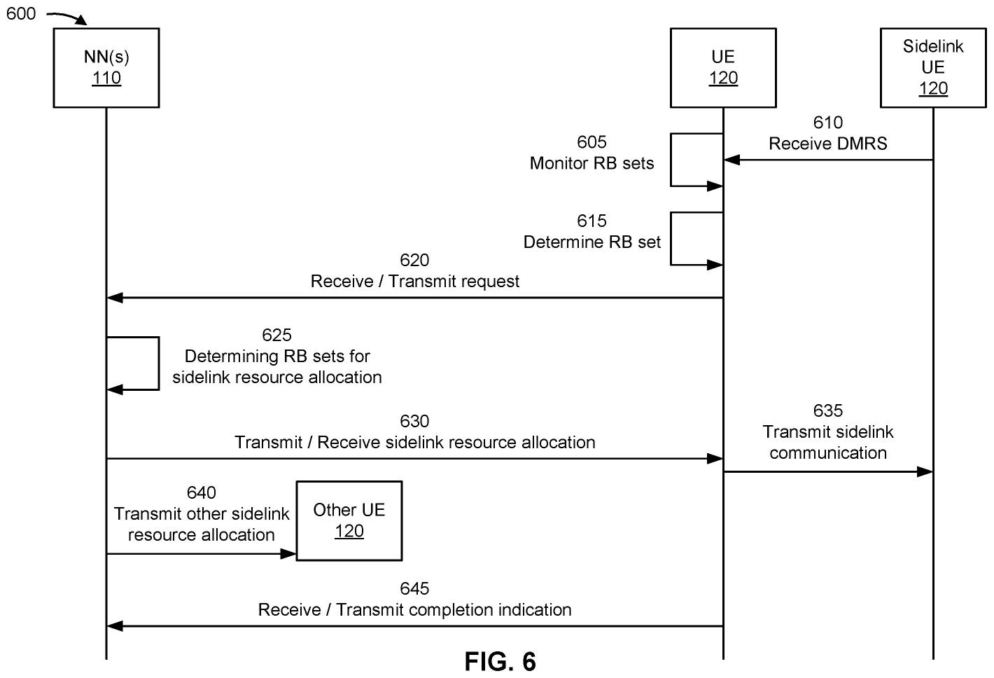

FIG. 6 is a diagram illustrating an example 600 associated with network-coordinated Mode 2 sidelink in an unlicensed spectrum, in accordance with the present disclosure. As shown in FIG. 6, a network node 110 may communicate with a UE (e.g., UE 120), a sidelink UE (e.g., UE 120), and/or another UE (e.g., UE 120). The UE and the sidelink UE may also communicate with one another. For example, the UE and the sidelink UE may communicate with one another via sidelink. As used herein, “sidelink communication” may refer to a combined PSCCH and PSSCH transmission, which may occur within one or more transmission opportunities.

As shown by reference number 605, the UE may monitor RB sets associated with the sidelink UE. For example, before requesting a sidelink resource allocation, the UE may monitor the unlicensed spectrum to identify which RB sets might have less traffic than others. For example, the UE may receive reference signals, such as demodulation reference signals (DMRSs) from other neighboring UEs (e.g., neighboring UEs that are within range of unlicensed spectrum communications of the UE). The UE may use the DMRSs to determine measures of received power associated with neighboring UEs (e.g., RSSI and/or RSRP, among other examples), in an effort to determine which neighboring UEs, if any, would satisfy an LBT threshold for sidelink communications. The reference signals may also be useful to determine channel occupancy and/or traffic loading in the unlicensed spectrum, which may facilitate choosing resources for sidelink communications, as described herein.

As shown by reference number 610, the sidelink UE may transmit, and the UE may receive, a reference signal, such as a DMRS. The UE may receive the reference signal while monitoring RB sets to identify neighboring devices that are using the unlicensed spectrum. As described herein, the reference signal may enable the UE to determine a channel occupancy, traffic loading, and/or likelihood of LBT success, among other examples.

As shown by reference number 615, the UE may determine at least one preferred RB set. For example, the UE may determine a preferred RB set based at least in part on monitoring the RB sets. By monitoring RB sets in the unlicensed spectrum, and determining signal strength based on received reference signals, the UE may be able to determine channel occupancy and traffic loading in the unlicensed spectrum. This may enable the UE to identify RB sets that might be good candidates for sidelink communications. For example, the UE may identify preferred RB sets that are associated with lower cell loading, lower channel occupancy, and/or lower reference signal strength traffic, relative to other RB sets in the unlicensed spectrum. Additionally, or alternatively, the UE may use an LBT success rate to identify preferred RB sets. The LBT success rate may be based, for example, on past LBT procedures performed for the sidelink UE to which the UE is to communicate and/or based on an estimated LBT success rate determined from signal strengths of reference signals received from the sidelink UE.

As shown by reference number 620, the UE may transmit, and the network node may receive, a request. The request may indicate one or more parameters associated with sidelink communications in the unlicensed spectrum. For example, the request may indicate that the UE is requesting an allocation of sidelink resources for sidelink communications (e.g., with the sidelink UE). In some aspects, the request may be associated with one or more preferred RB sets identified by the UE. For example, in a situation where the UE identified preferred RB sets, the UE may indicate the preferred RB sets in the request or in another communication in association with the request.

In some aspects, the request may be transmitted via a scheduling request (SR). For example, the SR may indicate that the UE is requesting an allocation of sidelink resources in the unlicensed spectrum to communicate with another UE. In some aspects, the request is transmitted via a buffer status report (BSR). In some aspects, the one or more parameters may indicate a buffer size (e.g., indicating an amount of traffic to be transmitted by the UE), an expected rank and modulation and coding scheme (MCS) to be used for sidelink communications, one or more preferred RB sets, channel occupancy information associated with the unlicensed spectrum, RSSI measurements associated with reference signals received by the UE, and/or an LBT success rate associated with the UE and the sidelink UE, among other examples. For example, the UE may transmit control signaling that identifies one or more other UEs that are associated with a power measurement that satisfies an LBT energy detection threshold (e.g., a threshold that would result in LBT failure). The parameters associated with the request may enable the network node to identify sidelink resources that might best serve the UE for sidelink communications with the sidelink UE.

In some aspects, the network node receives information regarding the unlicensed spectrum from one or more other UEs (not depicted in FIG. 6). The information received from other UEs may also include any of the information associated with the request, as described herein, and may include other requests for sidelink resource allocations. For example, the network node may receive (e.g., periodically and/or on-demand) information from other UEs in communication with the network node. The information provided by the other UEs may be used by the network node for determining traffic loading associated with the unlicensed spectrum, which may facilitate selection of unlicensed spectrum resources to allocate for sidelink communications, as described herein.

As shown by reference number 625, the network node may determine one or more RB sets for sidelink resource allocation. For example, the network node may determine the one or more RB sets based at least in part on the parameters associated with the request and/or other information regarding the unlicensed spectrum received from other UEs.

In some aspects, the network node may determine (e.g., select) the RB sets to allocate based at least in part on the preferred RB sets associated with the request. For example, in a situation where the UE has indicated preferred RB sets, the network node may determine to select the preferred RB sets to allocate to the UE. In some aspects, the network node may determine RB sets, other than the preferred RB sets. For example, in a situation where at least some of the preferred RB sets are in use by other UEs and/or associated with a conflicting request (e.g., as determined by information included in the request from the UE or other information provided by other UEs in communication with the network node), the network node may determine that at least one of the preferred RB sets will not be allocated for the UE.

In some aspects, the network node may not receive an indication of preferred RB sets, in which case the network node may determine RB sets to allocate based on other information associated with the request from the UE and, if available, information regarding the unlicensed spectrum received from other UEs. In some aspects, the network node may determine to allocate RB sets based at least in part on a number of UEs assigned to the RB sets. For example, the network node may be aware of other UEs already using various RB sets in the unlicensed spectrum. Multiple UEs may be able to use the same RB set, for example, in a situation where the UEs are not proximate to one another such that communications would not collide or otherwise interfere with one another. In a situation where RB sets are already allocated to other UEs, the network node may determine to assign the least-used RB sets for the UE.

In some aspects, the network node may determine the sidelink resource allocation based at least in part on information received from other UEs. For example, for other UEs, the network node may receive channel occupancy measurements, RSSI measurements, and/or LBT success rates that can be used to determine which UEs are in communication with, and/or in range of, which other UEs. In this situation, the network node may perform load balancing by allocating sidelink resources in the unlicensed spectrum in a manner that accounts for which UEs are likely to interfere with which other UEs. For example, a first UE in a first set of UEs, that are able to communicate with one another and detect one another's reference signals, may use a particular RB set in the unlicensed spectrum for sidelink communications, while a second UE in a second set of UEs, which are not in communication with the first set of UEs, may be assigned the same RB set. In this situation, the sidelink communications should not interfere, as the network node allocated the sidelink resources based on the information indicating which UEs were likely to interfere with which other UEs.

By using information received from the UE, or from other UEs, regarding the unlicensed spectrum, the network node is able to determine a sidelink resource allocation for the UE that is less likely to interfere with other communications in the unlicensed spectrum.

As shown by reference number 630, the network node may transmit, and the UE may receive, the sidelink resource allocation. The sidelink resource allocation may indicate one or more RB sets associated with the unlicensed spectrum. For example, the sidelink resource allocation may identify multiple RB sets that the UE may use for scheduling sidelink communications in the unlicensed spectrum.

In some aspects, the sidelink resource allocation may be a persistent allocation (e.g., an allocation that continues until terminated by time or an indication from the UE). The persistent allocation may be associated with an expiration time, after which the sidelink resource allocation will expire. In some aspects, the network node may determine the expiration time based at least in part on the BSR received from the UE. For example, the expiration time may be longer in a case where the buffer includes a relatively significant amount of data to be transmitted and/or if the sidelink transmissions are to occur with a lower MCS (e.g., a lower data rate), and the expiration time may be shorter in a case where the buffer includes relatively little data to transmit and/or if the sidelink transmissions are to use a higher MCS (e.g., a higher data rate). In some aspects, the persistent allocation may be terminated based on control signaling received from the UE. For example, a UE may terminate the persistent allocation by sending a control signal (e.g., via PUCCH or medium access control (MAC) control element) indicating that the UE is finished with sidelink communications.

As shown by reference number 635, the UE may transmit a sidelink communication to the sidelink UE. For example, the sidelink communication may be transmitted in the unlicensed spectrum using the RB set(s) indicated by the sidelink resource allocation. The UE may also use an LBT procedure for the sidelink communications. While the sidelink resource allocation may be determined in a manner designed to minimize the likelihood of interference that might cause LBT failure, the UE may still perform LBT prior to transmitting on the allocation RB sets. In a situation where the RB sets are not sufficient for the sidelink communications (e.g., due to LBT failures and/or due to additional data the UE is to send, among other examples), the UE may request another sidelink resource allocation. In a situation where the RB sets are part of a persistent allocation, the UE may continue to communicate with the sidelink UE via the allocated RB sets until the persistent allocation is terminated (e.g., by expiration time and/or UE indication).

As shown by reference number 640, the network node may transmit another sidelink resource allocation to another UE. In some aspects, the other sidelink resource allocation may include one or more RB sets that are the same RB sets as those allocated to the UE as part of the sidelink resource allocation. For example, in this situation, the network node may have determined that the other UE is not likely to interfere with the UE (e.g., based at least in part on information received from the UE and/or other UEs) and, as a result, the network node can allocate the same RB sets to both UEs. While the network node may not be able to guarantee that there will be no interference between the other UE and the UE, by using the received information to allocate RB sets, the likelihood of interference may be minimized. This may enable the network node to perform load balancing in the unlicensed spectrum for sidelink communications that are allocated by the network node but scheduled by the UEs.

As shown by reference number 645, the UE may transmit, and the network node may receive, an indication that the UE has completed sidelink communications using the allocated RB sets. For example, the indication may be a control signal indication transmitted via PSCCH or MAC control element. The indication enables the network node to end a persistent allocation of sidelink resources, which may free up the RB sets for allocation to another UE or UEs.

By using network coordinated resource allocation, the network node is able to provide the UE with a sidelink resource allocation that uses information about the unlicensed spectrum. The information provided to the network node may enable the network node to allocate resources (e.g., RB sets) to different UEs that are using the unlicensed spectrum, in a way that facilitates prevention of LBT failures, collisions, and interference. In this way, the network node may perform load balancing in the unlicensed spectrum for sidelink communications, where the resources for the sidelink communications are allocated by the network node (e.g., as in Mode 1) but scheduled by the UE (e.g., as in Mode 2). This may result in fewer dropped communications and/or LBT failures in the unlicensed spectrum, which may lead to less processing and network resources being consumed to schedule and reschedule communications, and may also lead to improved latency for sidelink communications by allocating resources that are more likely to pass an LBT procedure.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with network-coordinated Mode 2 sidelink in unlicensed spectrum.

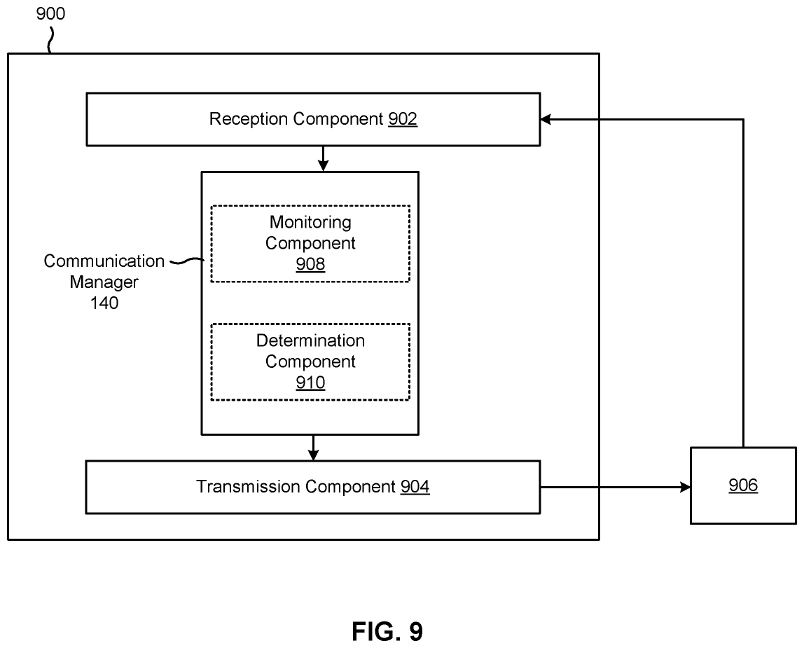

As shown in FIG. 7, in some aspects, process 700 may include transmitting, to a network node and via a BSR or SR, a request indicating one or more parameters associated with sidelink communications in an unlicensed spectrum (block 710). For example, the UE (e.g., using communication manager 140 and/or transmission component 904, depicted in FIG. 9) may transmit, to a network node and via a BSR or SR, a request indicating one or more parameters associated with sidelink communications in an unlicensed spectrum, as described above.

As further shown in FIG. 7, in some aspects, process 700 may include receiving, from the network node, a sidelink resource allocation indicating one or more RB sets associated with the unlicensed spectrum (block 720). For example, the UE (e.g., using communication manager 140 and/or reception component 902, depicted in FIG. 9) may receive, from the network node, a sidelink resource allocation indicating one or more RB sets associated with the unlicensed spectrum, as described above.

As further shown in FIG. 7, in some aspects, process 700 may include transmitting, to a sidelink UE and based at least in part on the sidelink resource allocation and on a result of performing LBT, a sidelink communication (block 730). For example, the UE (e.g., using communication manager 140 and/or transmission component 904, depicted in FIG. 9) may transmit, to a sidelink UE and based at least in part on the sidelink resource allocation and on a result of performing LBT, a sidelink communication, as described above.

Process 700 may include additional aspects, such as any single aspect or any combination of aspects described below and/or in connection with one or more other processes described elsewhere herein.

In a first aspect, the request is transmitted via the BSR, and the BSR indicates at least one preferred RB set.

In a second aspect, alone or in combination with the first aspect, process 700 includes monitoring a plurality of RB sets associated with the sidelink UE, and determining the at least one preferred RB set, from the plurality of RB sets, based at least in part on the monitoring.

In a third aspect, alone or in combination with one or more of the first and second aspects, process 700 includes determining the at least one preferred RB set based at least in part on an LBT success rate associated with the at least one preferred RB set.

In a fourth aspect, alone or in combination with one or more of the first through third aspects, the sidelink resource allocation is a persistent allocation associated with an expiration time.

In a fifth aspect, alone or in combination with one or more of the first through fourth aspects, process 700 includes transmitting, to the network node, a control signal indicating completion of sidelink communications in the unlicensed spectrum.

In a sixth aspect, alone or in combination with one or more of the first through fifth aspects, transmitting the control signal comprises at least one of transmitting the control signal via a PUCCH communication, or transmitting the control signal via a MAC control element.

In a seventh aspect, alone or in combination with one or more of the first through sixth aspects, process 700 includes receiving, from at least one other UE, a demodulation reference signal, and transmitting, to the network node and based at least in part on the demodulation reference signal, a control signal that identifies one or more UEs of the at least one other UE.

In an eighth aspect, alone or in combination with one or more of the first through seventh aspects, the control signal that identifies the one or more UEs indicates that the one or more UEs are associated with a power measurement that satisfies an LBT energy detection threshold.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with network-coordinated Mode 2 sidelink in unlicensed spectrum.

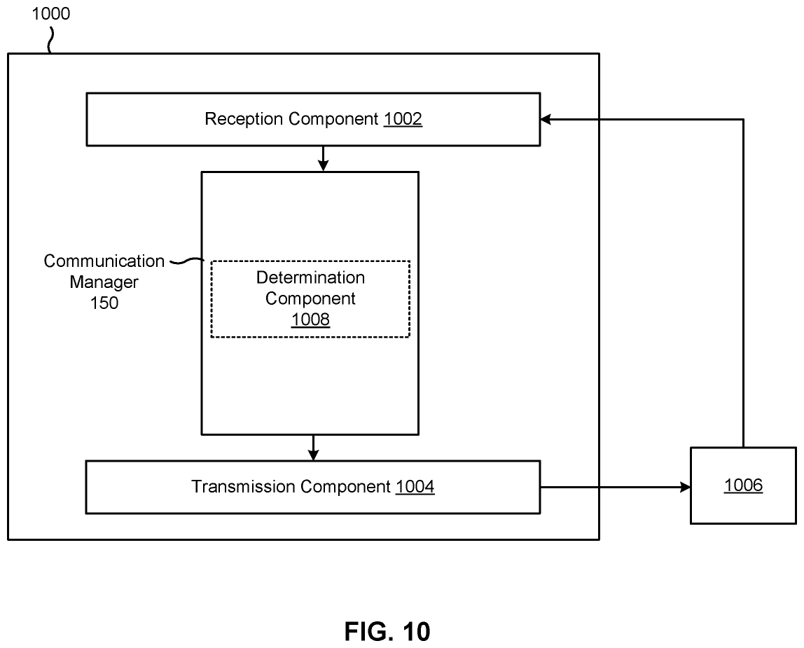

As shown in FIG. 8, in some aspects, process 800 may include receiving, from a UE and via a BSR or SR, a request indicating one or more parameters associated with sidelink communications in an unlicensed spectrum (block 810). For example, the network node (e.g., using communication manager 150 and/or reception component 1002, depicted in FIG. 10) may receive, from a UE and via a BSR or SR, a request indicating one or more parameters associated with sidelink communications in an unlicensed spectrum, as described above.

As further shown in FIG. 8, in some aspects, process 800 may include transmitting, to the UE, a sidelink resource allocation indicating one or more RB sets associated with the unlicensed spectrum (block 820). For example, the network node (e.g., using communication manager 150 and/or transmission component 1004, depicted in FIG. 10) may transmit, to the UE, a sidelink resource allocation indicating one or more RB sets associated with the unlicensed spectrum, as described above.

Process 800 may include additional aspects, such as any single aspect or any combination of aspects described below and/or in connection with one or more other processes described elsewhere herein.

In a first aspect, the request is transmitted via the BSR, and the BSR indicates at least one preferred RB set.

In a second aspect, alone or in combination with the first aspect, process 800 includes selecting, from a plurality of RB sets, the one or more RB sets for the sidelink resource allocation based at least in part on the at least one preferred RB set.

In a third aspect, alone or in combination with one or more of the first and second aspects, the sidelink resource allocation is a persistent allocation associated with an expiration time.

In a fourth aspect, alone or in combination with one or more of the first through third aspects, process 800 includes determining the expiration time based at least in part on information indicated by the BSR or SR.

In a fifth aspect, alone or in combination with one or more of the first through fourth aspects, process 800 includes receiving, from the UE, a control signal indicating completion of sidelink communications in the unlicensed spectrum.

In a sixth aspect, alone or in combination with one or more of the first through fifth aspects, receiving the control signal comprises at least one of receiving the control signal via a PUCCH communication, or receiving the control signal via a MAC control element.

In a seventh aspect, alone or in combination with one or more of the first through sixth aspects, process 800 includes determining the sidelink resource allocation based at least in part on a number of sidelink UEs assigned to each of the one or more RB sets.

In an eighth aspect, alone or in combination with one or more of the first through seventh aspects, process 800 includes determining the sidelink resource allocation based at least in part on information received from one or more UEs, the information indicating at least one of a channel occupancy measurement, a received signal strength indicator measurement, or an LBT success rate.

In a ninth aspect, alone or in combination with one or more of the first through eighth aspects, process 800 includes receiving, from the UE, a control signal identifying at least one neighboring UE associated with the UE, and determining the sidelink resource allocation based at least in part on the control signal identifying the at least one neighboring UE.

In a tenth aspect, alone or in combination with one or more of the first through ninth aspects, the control signal identifying the at least one neighboring UE indicates that each neighboring UE, of the at least one neighboring UE, is associated with a power measurement that satisfies an LBT energy detection threshold.

In an eleventh aspect, alone or in combination with one or more of the first through tenth aspects, determining the sidelink resource allocation further comprises determining that the one or more RB sets are available for the sidelink resource allocation based at least in part on determining that the one or more RB sets are not being used by the at least one neighboring UE.

In a twelfth aspect, alone or in combination with one or more of the first through eleventh aspects, process 800 includes determining, for another UE, that the other UE is not associated with the UE or the at least one neighboring UE, and transmitting, to the other UE, another sidelink resource allocation indicating at least one of the one or more RB sets.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a monitoring component 908, or a determination component 910, among other examples.

In some aspects, the apparatus 900 may be configured to perform one or more operations described herein in connection with FIGS. 3-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The transmission component 904 may transmit, to a network node and via a BSR or SR, a request indicating one or more parameters associated with sidelink communications in an unlicensed spectrum. The reception component 902 may receive, from the network node, a sidelink resource allocation indicating one or more RB sets associated with the unlicensed spectrum. The transmission component 904 may transmit, to a sidelink UE and based at least in part on the sidelink resource allocation and on a result of performing LBT, a sidelink communication.

The monitoring component 908 may monitor a plurality of RB sets associated with the sidelink UE.

The determination component 910 may determine the at least one preferred RB set, from the plurality of RB sets, based at least in part on the monitoring.

The determination component 910 may determine the at least one preferred RB set based at least in part on an LBT success rate associated with the at least one preferred RB set.

The transmission component 904 may transmit, to the network node, a control signal indicating completion of sidelink communications in the unlicensed spectrum.

The reception component 902 may receive, from at least one other UE, a demodulation reference signal.

The transmission component 904 may transmit, to the network node and based at least in part on the demodulation reference signal, a control signal that identifies one or more UEs of the at least one other UE.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150) may include a determination component 1008, among other examples.

In some aspects, the apparatus 1000 may be configured to perform one or more operations described herein in connection with FIGS. 3-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The reception component 1002 may receive, from a UE and via a BSR or SR, a request indicating one or more parameters associated with sidelink communications in an unlicensed spectrum. The transmission component 1004 may transmit, to the UE, a sidelink resource allocation indicating one or more RB sets associated with the unlicensed spectrum.

The determination component 1008 may select, from a plurality of RB sets, the one or more RB sets for the sidelink resource allocation based at least in part on the at least one preferred RB set.

The determination component 1008 may determine the expiration time based at least in part on information indicated by the BSR or SR.

The reception component 1002 may receive, from the UE, a control signal indicating completion of sidelink communications in the unlicensed spectrum.

The determination component 1008 may determine the sidelink resource allocation based at least in part on a number of sidelink UEs assigned to each of the one or more RB sets.

The determination component 1008 may determine the sidelink resource allocation based at least in part on information received from one or more UEs, the information indicating at least one of a channel occupancy measurement, a received signal strength indicator measurement, or an LBT success rate.

The reception component 1002 may receive, from the UE, a control signal identifying at least one neighboring UE associated with the UE.

The determination component 1008 may determine the sidelink resource allocation based at least in part on the control signal identifying the at least one neighboring UE.

The determination component 1008 may determine, for another UE, that the other UE is not associated with the UE or the at least one neighboring UE.

The transmission component 1004 may transmit, to the other UE, another sidelink resource allocation indicating at least one of the one or more RB sets.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: transmitting, to a network node and via a BSR or SR, a request indicating one or more parameters associated with sidelink communications in an unlicensed spectrum; receiving, from the network node, a sidelink resource allocation indicating one or more RB sets associated with the unlicensed spectrum; and transmitting, to a sidelink UE and based at least in part on the sidelink resource allocation and on a result of performing LBT, a sidelink communication.

Aspect 2: The method of Aspect 1, wherein the request is transmitted via the BSR, and wherein the BSR indicates at least one preferred RB set.

Aspect 3: The method of Aspect 2, further comprising: monitoring a plurality of RB sets associated with the sidelink UE; and determining the at least one preferred RB set, from the plurality of RB sets, based at least in part on the monitoring.

Aspect 4: The method of Aspect 2, further comprising: determining the at least one preferred RB set based at least in part on an LBT success rate associated with the at least one preferred RB set.

Aspect 5: The method of any of Aspects 1-4, wherein the sidelink resource allocation is a persistent allocation associated with an expiration time.

Aspect 6: The method of any of Aspects 1-5, further comprising: transmitting, to the network node, a control signal indicating completion of sidelink communications in the unlicensed spectrum.

Aspect 7: The method of Aspect 6, wherein transmitting the control signal comprises at least one of: transmitting the control signal via a PUCCH communication, or transmitting the control signal via a MAC control element.

Aspect 8: The method of any of Aspects 1-7, further comprising: receiving, from at least one other UE, a demodulation reference signal; and transmitting, to the network node and based at least in part on the demodulation reference signal, a control signal that identifies one or more UEs of the at least one other UE.

Aspect 9: The method of Aspect 8, wherein the control signal that identifies the one or more UEs indicates that the one or more UEs are associated with a power measurement that satisfies an LBT energy detection threshold.

Aspect 10: A method of wireless communication performed by a network node, comprising: receiving, from a UE and via a BSR or SR, a request indicating one or more parameters associated with sidelink communications in an unlicensed spectrum; and transmitting, to the UE, a sidelink resource allocation indicating one or more RB sets associated with the unlicensed spectrum.

Aspect 11: The method of Aspect 10, wherein the request is transmitted via the BSR, and wherein the BSR indicates at least one preferred RB set.

Aspect 12: The method of Aspect 11, further comprising: selecting, from a plurality of RB sets, the one or more RB sets for the sidelink resource allocation based at least in part on the at least one preferred RB set.

Aspect 13: The method of any of Aspects 10-12, wherein the sidelink resource allocation is a persistent allocation associated with an expiration time.

Aspect 14: The method of Aspect 13, further comprising: determining the expiration time based at least in part on information indicated by the BSR or SR.

Aspect 15: The method of any of Aspects 10-14, further comprising: receiving, from the UE, a control signal indicating completion of sidelink communications in the unlicensed spectrum.

Aspect 16: The method of Aspect 15, wherein receiving the control signal comprises at least one of: receiving the control signal via a PUCCH communication, or receiving the control signal via a MAC control element.

Aspect 17: The method of any of Aspects 10-16, further comprising: determining the sidelink resource allocation based at least in part on a number of sidelink UEs assigned to each of the one or more RB sets.

Aspect 18: The method of any of Aspects 10-17, further comprising: determining the sidelink resource allocation based at least in part on information received from one or more UEs, the information indicating at least one of: a channel occupancy measurement, a received signal strength indicator measurement, or an LBT success rate.

Aspect 19: The method of any of Aspects 10-18, further comprising: receiving, from the UE, a control signal identifying at least one neighboring UE associated with the UE; and determining the sidelink resource allocation based at least in part on the control signal identifying the at least one neighboring UE.

Aspect 20: The method of Aspect 19, wherein the control signal identifying the at least one neighboring UE indicates that each neighboring UE, of the at least one neighboring UE, is associated with a power measurement that satisfies an LBT energy detection threshold.

Aspect 21: The method of Aspect 19, wherein determining the sidelink resource allocation further comprises: determining that the one or more RB sets are available for the sidelink resource allocation based at least in part on determining that the one or more RB sets are not being used by the at least one neighboring UE.

Aspect 22: The method of Aspect 21, further comprising: determining, for another UE, that the other UE is not associated with the UE or the at least one neighboring UE; and transmitting, to the other UE, another sidelink resource allocation indicating at least one of the one or more RB sets.

Aspect 23: An apparatus for wireless communication at a device, comprising a processor; memory coupled with the processor; and instructions stored in the memory and executable by the processor to cause the apparatus to perform the method of one or more of Aspects 1-9.

Aspect 24: An apparatus for wireless communication at a device, comprising a processor; memory coupled with the processor; and instructions stored in the memory and executable by the processor to cause the apparatus to perform the method of one or more of Aspects 10-22.

Aspect 25: A device for wireless communication, comprising a memory and one or more processors coupled to the memory, the one or more processors configured to perform the method of one or more of Aspects 1-9.

Aspect 26: A device for wireless communication, comprising a memory and one or more processors coupled to the memory, the one or more processors configured to perform the method of one or more of Aspects 10-22.

Aspect 27: An apparatus for wireless communication, comprising at least one means for performing the method of one or more of Aspects 1-9.

Aspect 28: An apparatus for wireless communication, comprising at least one means for performing the method of one or more of Aspects 10-22.

Aspect 29: A non-transitory computer-readable medium storing code for wireless communication, the code comprising instructions executable by a processor to perform the method of one or more of Aspects 1-9.

Aspect 30: A non-transitory computer-readable medium storing code for wireless communication, the code comprising instructions executable by a processor to perform the method of one or more of Aspects 10-22.

Aspect 31: A non-transitory computer-readable medium storing a set of instructions for wireless communication, the set of instructions comprising one or more instructions that, when executed by one or more processors of a device, cause the device to perform the method of one or more of Aspects 1-9.

Aspect 32: A non-transitory computer-readable medium storing a set of instructions for wireless communication, the set of instructions comprising one or more instructions that, when executed by one or more processors of a device, cause the device to perform the method of one or more of Aspects 10-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit, to a network node and via a buffer status report (BSR) or scheduling request (SR), a request indicating one or more parameters associated with sidelink communications in an unlicensed spectrum;
receive, from the network node, a sidelink resource allocation indicating one or more resource block (RB) sets associated with the unlicensed spectrum; and
transmit, to a sidelink UE and based at least in part on the sidelink resource allocation and on a result of performing listen-before-talk (LBT), a sidelink communication.

2. The UE of claim 1, wherein the request is transmitted via the BSR, and wherein the BSR indicates at least one preferred RB set.

3. The UE of claim 2, wherein the one or more processors are further configured to:
monitor a plurality of RB sets associated with the sidelink UE; and
determine the at least one preferred RB set, from the plurality of RB sets, based at least in part on the monitoring.

4. The UE of claim 2, wherein the one or more processors are further configured to:
determine the at least one preferred RB set based at least in part on an LBT success rate associated with the at least one preferred RB set.

5. The UE of claim 1, wherein the sidelink resource allocation is a persistent allocation associated with an expiration time.

6. The UE of claim 1, wherein the one or more processors are further configured to:
transmit, to the network node, a control signal indicating completion of sidelink communications in the unlicensed spectrum.

7. The UE of claim 6, wherein the one or more processors, to transmit the control signal, are configured to:
transmit the control signal via a physical uplink control channel (PUCCH) communication, or
transmit the control signal via a medium access control (MAC) control element.

8. The UE of claim 1, wherein the one or more processors are further configured to:
receive, from at least one other UE, a demodulation reference signal; and
transmit, to the network node and based at least in part on the demodulation reference signal, a control signal that identifies one or more UEs of the at least one other UE.

9. The UE of claim 8, wherein the control signal that identifies the one or more UEs indicates that the one or more UEs are associated with a power measurement that satisfies an LBT energy detection threshold.

10. A network node for wireless communication, comprising:
a memory; and
one or more processors, coupled to the memory, configured to:
receive, from a user equipment (UE) and via a buffer status report (BSR) or scheduling request (SR), a request indicating one or more parameters associated with sidelink communications in an unlicensed spectrum; and
transmit, to the UE, a sidelink resource allocation indicating one or more resource block (RB) sets associated with the unlicensed spectrum.

11. The network node of claim 10, wherein the request is transmitted via the BSR, and wherein the BSR indicates at least one preferred RB set.

12. The network node of claim 11, wherein the one or more processors are further configured to:
select, from a plurality of RB sets, the one or more RB sets for the sidelink resource allocation based at least in part on the at least one preferred RB set.

13. The network node of claim 10, wherein the sidelink resource allocation is a persistent allocation associated with an expiration time.

14. The network node of claim 13, wherein the one or more processors are further configured to:
determine the expiration time based at least in part on information indicated by the BSR or SR.

15. The network node of claim 10, wherein the one or more processors are further configured to:
receive, from the UE, a control signal indicating completion of sidelink communications in the unlicensed spectrum.

16. The network node of claim 15, wherein the one or more processors, to receive the control signal, are configured to:
receive the control signal via a physical uplink control channel (PUCCH) communication, or
receive the control signal via a medium access control (MAC) control element.

17. The network node of claim 10, wherein the one or more processors are further configured to:
determine the sidelink resource allocation based at least in part on a number of sidelink UEs assigned to each of the one or more RB sets.

18. The network node of claim 10, wherein the one or more processors are further configured to:
determine the sidelink resource allocation based at least in part on information received from one or more UEs, the information indicating at least one of:
a channel occupancy measurement,
a received signal strength indicator measurement, or
an LBT success rate.

19. The network node of claim 10, wherein the one or more processors are further configured to:
receive, from the UE, a control signal identifying at least one neighboring UE associated with the UE; and
determine the sidelink resource allocation based at least in part on the control signal identifying the at least one neighboring UE.

20. The network node of claim 19, wherein the control signal identifying the at least one neighboring UE indicates that each neighboring UE, of the at least one neighboring UE, is associated with a power measurement that satisfies an LBT energy detection threshold.

21. The network node of claim 19, wherein the one or more processors, to determine the sidelink resource allocation, are configured to:
determine that the one or more RB sets are available for the sidelink resource allocation based at least in part on determining that the one or more RB sets are not being used by the at least one neighboring UE.

22. The network node of claim 21, wherein the one or more processors are further configured to:
determine, for another UE, that the other UE is not associated with the UE or the at least one neighboring UE; and
transmit, to the other UE, another sidelink resource allocation indicating at least one of the one or more RB sets.

23. A method of wireless communication performed by a user equipment (UE), comprising:
transmitting, to a network node and via a buffer status report (BSR) or scheduling request (SR), a request indicating one or more parameters associated with sidelink communications in an unlicensed spectrum;
receiving, from the network node, a sidelink resource allocation indicating one or more resource block (RB) sets associated with the unlicensed spectrum; and
transmitting, to a sidelink UE and based at least in part on the sidelink resource allocation and on a result of performing listen-before-talk (LBT), a sidelink communication.

24. The method of claim 23, further comprising:
monitoring a plurality of RB sets associated with the sidelink UE; and
determining at least one preferred RB set, from the plurality of RB sets, based at least in part on the monitoring,
wherein the request is transmitted via the BSR, and wherein the BSR indicates at least one preferred RB set.

25. The method of claim 23, further comprising:
receiving, from at least one other UE, a demodulation reference signal; and
transmitting, to the network node and based at least in part on the demodulation reference signal, a control signal that identifies one or more UEs of the at least one other UE.

26. The method of claim 25, wherein the control signal that identifies the one or more UEs indicates that the one or more UEs are associated with a power measurement that satisfies an LBT energy detection threshold.

27. A method of wireless communication performed by a network node, comprising:
receiving, from a user equipment (UE) and via a buffer status report (BSR) or scheduling request (SR), a request indicating one or more parameters associated with sidelink communications in an unlicensed spectrum; and
transmitting, to the UE, a sidelink resource allocation indicating one or more resource block (RB) sets associated with the unlicensed spectrum.

28. The method of claim 27, further comprising:
determining the sidelink resource allocation based at least in part on information received from one or more UEs, the information indicating at least one of:
a channel occupancy measurement,
a received signal strength indicator measurement, or
an LBT success rate.

29. The method of claim 27, further comprising:
receiving, from the UE, a control signal identifying at least one neighboring UE associated with the UE; and
determining the sidelink resource allocation based at least in part on the control signal identifying the at least one neighboring UE.

30. The method of claim 29, wherein the control signal identifying the at least one neighboring UE indicates that each neighboring UE, of the at least one neighboring UE, is associated with a power measurement that satisfies an LBT energy detection threshold.
